(19) United States
(12) Patent Application Publication
(10) Pub. No.: US 2009/0318726 A1
(43) Pub. Date: Dec. 24, 2009

(54) NEW SILYLSUBSTITUTED 1,2-ALKYNES AND SYNTHESIS OF SILYLSUBSTITUTED 1,2-ALKYNES

(75) Inventors: Bogdan Marciniec, Poznan (PL); Beata Dudziec, Poznan (PL); Karol Szubert, Czerwonak (PL); Jedrzej Walkowiak, Poznan (PL)

Correspondence Address: OLIFF & BERRIDGE, PLC, P.O. BOX 320850, ALEXANDRIA, VA, 22320-4850, US

(73) Assignee: ADAM MICKIEWICZ UNIVERSITY, POZNAN (PL)

(21) Appl. No.: 12/310,168

(22) PCT Filed: Aug. 14, 2007
(86) PCT No.: PCT/PL2007/000057

§ 371 Date: Feb. 13, 2009

(30) Foreign Application Priority Data
Aug. 16, 2006 (PL) P-380422
Jul. 13, 2007 (PL) P-382914

(51) Int. Cl. C07F 7/08

(52) U.S. Cl. 556/478; 556/489

(57) ABSTRACT

New silylsubstituted 1,2-alkynes of the general formula 1 and a new way of synthesis of new and already known silylsubstituted 1,2-alkynes of the general formula 1. The unknown silylsubstituted 1,2-alkynes of general formula 1, in which R¹ stands for trialkoxysilyl group, dimethyl(trimethylsiloxy)silyl group, phenyldimethylsilyl group, methylbis(trimethylsiloxy)silyl group; R² stands for alkyl, trialkylsilyl group with all alkyl substituents the same, 1-trimethylsiloxycycloalkyl group, cycloalkyl group, tertbutyl group, 1-trimethylsiloxyalkyl group, tertbutyldimethylsilyl group or 1-alkoxyalkyl group. The subject matter of the invention is a new way of synthesis of new and already known silylsubstituted 1,2-alkynes of general formula 1, in which R¹ and R² specified above, in which an alkene of general formula 2, with R¹ specified above is subjected to silylative coupling with a terminal alkynes of the general formula 3, with R² specified above, in the presence of a catalyst.

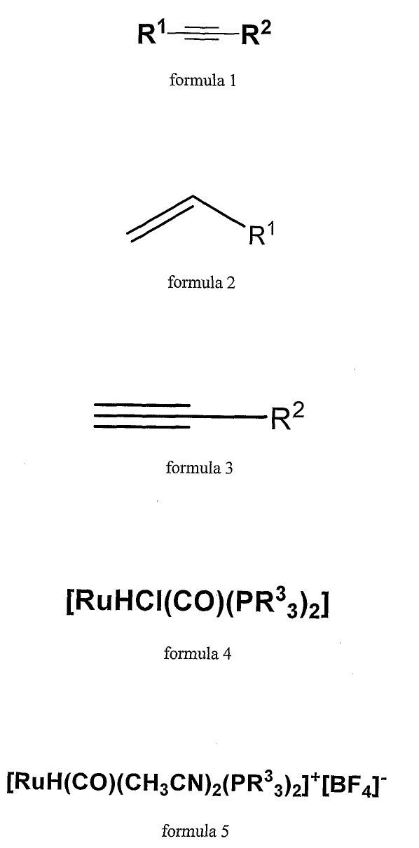

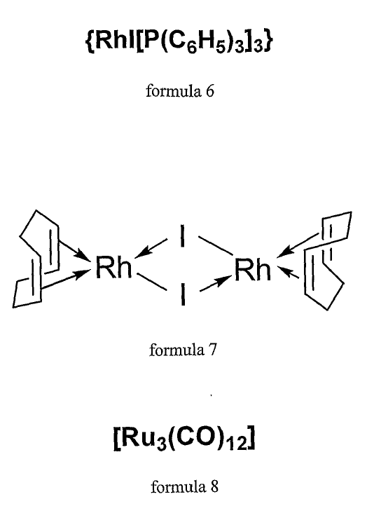

The subject of the invention are new silylsubstituted 1,2-alkynes of the general formula 1 and a new way of synthesis of new and already known silylsubstituted 1,2-alkynes of the general formula 1.

A few methods of synthesis of silylsubstituted 1,2-alkynes have been hitherto proposed and used.

The most often used is the reaction of chlorosubstituted silanes with lithium- or magnesium substituted alkynes (Baba, T.; Kato, A.; Talcahanashi, H.; Toriyama, F.; Handa, H.; Ono, Y.; Sugisawa, H. J. Catal. 1998, 176, 488-494; Brandsma, L.; Verkruijsse, H. D. Synthesis, 1999, 1727-1728), also in the presents of palladium complexes (Yang, L.-M.; Huang, L.-F.; Luh, T.-Y. Org. Lett. 2004, 6, 1461-1463). Another very popular method of synthesis of silylsubstituted 1,2-alkynes is the Sonogashira reaction of silylsubstituted terminal alkynes with alkyl or aryl halides the presence of palladium complexes in triethylamine (Sonogashira, K.; Tohda, Y.; Hagihara, N. Tetrahedron Lett. 1975, 4467; Talkahashi, S.; Kuroyama, Y.; Sonogashira, K.; Hagihara, N. Synthesis, 1980, 627; Uenishi, J.; Matsui, K. Tetrahedron Lett. 2001, 42, 4353-4355). The direct methods of synthesis of silylsubstituted 1,2-alkynes include: direct silylation of terminal alkynes with aminosilanes in the presence of zinc halides in 1,4-dioxane (Anreev, A. A.; Konshin, V. V.; Komarov, N. V.; Rubin, M.; Brouwer, Ch.; Gevorgyan, V. Org. Lett. 2004, 6, 421-424), and direct silylation of terminal alkynes with chlorosilanes in the presence of zinc dust or zinc complexes (Sugita, H.; Hatanaka, Y.; Hiyama, T. Tetrahedron Lett. 1995, 36, 2769-2772; Jiang, H.; Zhu, S. Tetrahedron Lett. 2005, 46, 517-519). Another method of synthesis of silylsubstituted 1,2-alkynes is the reaction of terminal silylsubstituted alkynes with disulfides in the presence of rhodium complexes in acetone (Arisawa, M.; Fujimoto, K.; Morinalca, S.; Yamaguchi, M. J. Am. Chem. Soc. 2005, 127, 12226-12227). The relevant compounds can be also obtained by modification of silylsubstituted 1,2-alkynes by metathesis over a molybdenum catalyst (Fürstner, A.; Mathes, Ch. Org. Lett. 2001, 3, 221-223), or over palladium catalysts with addition of copper or silver halides (Chen, L.; Li, Ch.-J. Tetrahedron Lett. 2004, 45, 2771-2774; Halbes, U.; Pale, P. Tetrahedron Lett. 2002, 43, 2039-2042) or in addition of phosphines (Trost, B. M.; McIntosh, M. C. Tetrahedron Lett. 1997, 38, 3207-3210; Trost, B. M.; Sorum, M. T.; Chan, Ch.; Harms, A. E.; Rühter, G. J. Am. Chem. Soc. 1997, 119, 698-708), or in the presence of ruthenium catalysts (Yi, Ch. S.; Liu, N. Organometallics 1998, 17, 3158-3160) or cesium fluorides and crown ethers (Lukevics, E.; Rubia, K.; Abele, E.; Fleisher, M.; Arsenyan, P.; Grīnberga, S.; Popelis, J. J. Organomet. Chem. 2001, 634, 69-73). They also have been synthesized by dehydrogenating silylation of terminal alkynes with silanes in the presence of iridium complexes (Fernandez, M. J.; Oro, A. J. J. Mol. Catal. 1988, 45, 7-15; Esteruelas, M. A.; Nurnberg, O.; Oliván, M.; Oro, L. A. Organometallics 1993, 12, 3264-3272; Shimizu, R.; Fuchikami, T. Tetrahedron Lett. 2000, 41, 907-910) or ytterbium complexes (Talcalci, K.; Kurioka, M.; Kamata, T.; Takehira, K.; Makioka, Y.; Fujiwara, Y. J. Org. Chem. 1998, 63, 9265-9269) or lithium or barium compounds (Ishikawa, J.; Itoh, M. J. Catal. 1999,185, 454-461; Itoh, M.; Kobayashi, M.; Ishikawa, J. Organometallics 1997, 16, 3068-3070). The silylsubstituted 1,2-alkynes have been also synthesized by thermal desulfinylation of 2-trialkylsilylvinylsulfoxides (Nakamura, S.; Kusuda, A.; Kawamura, K. Toru, T. J. Org. Chem. 2002, 67, 640-647).

The silylsubstituted 1,2-alkynes obtained by the above-mentioned methods of synthesis contain considerable amounts of side products, which decreases the yield of the pure target product.

The subject of invention are new silylsubstituted 1,2-alkynes of the general formula 1 and a new way of synthesis of new and already known silylsubstituted 1,2-alkynes of the general formula 1.

The subject matter of the invention are new, hitherto unknown silylsubstituted 1,2-alkynes of general formula 1, in which R¹ stands for trialkoxysilyl group, dimethyl(trimethylsiloxy)silyl group, phenyldimethylsilyl group, methylbis(trimethylsiloxy)silyl group; R² stands for alkyl, trialkylsilyl group with all alkyl substituents the same, 1-trimethylsiloxycycloalkyl group, cycloalkyl group, tertbutyl group, 1-trimethylsiloxyalkyl group, tertbutyldimethylsilyl group or 1-alkoxyalkyl group. Silylsubstituted 1,2-alkynes of general formula 1, in which R¹ stands for a trialkoxysilyl group while R² stands for a trialkylsilyl group with all alkyl substituents the same or tertbutyl group and silylsubstituted 1,2-alkynes of general formula 1 in which R¹ stands for a phenyldimethylsilyl group while R² stands for a cycloalkyl, phenyldimethylsilyl or tertbutyl group are the known compounds.

The subject matter of the invention is a new way of synthesis of new and already known silylsubstituted 1,2-alkynes of general formula 1, in which R¹ stands for a trialkoxysilyl group, methylbis(trimethylsiloxy)silyl group, dimethyl(trimethylsiloxy)silyl group or phenyldimethylsilyl group, while R² stands for alkyl, tertbutyl, cycloalkyl, trialkylsilyl group with all alkyl substituents the same, 1-trimethylsiloxycycloalkyl group, phenyldimethylsilyl group, tertbutyldimethylsilyl group, 1-trimetylsiloxyalkyl group or 1-alkoxyalkyl group, in which an alkene of general formula 2, with R¹ specified above is subjected to silylative coupling with a terminal alkynes of the general formula 3, with R² specified above, in the presence of a catalyst.

According to the invention the reaction is conducted in temperatures from the range 100-130° C., possibly in the presence of a solvent, in particular hydrocarbon or aromatic solvent, preferably toluene, in a neutral gas atmosphere.

In the first version of the synthesis method proposed in the invention the catalyst is the compound of general formula 4 in which R³ stands for a cyclohexyl or isopropyl group.

In the second version of the synthesis method proposed in the invention the catalyst is the compound of general formula 5, with R³ as specified above.

In the third version of the synthesis method proposed in the invention the catalyst is iodotris(triphenylphosphine)rhodium (I) of formula 6.

In the fourth version of the synthesis method proposed in the invention the catalyst is di- di-μ-iodobis(1,5-cyclooctadiene)dirhodiuwn (I) of formula 7.

In the fifth version of the synthesis method proposed in the invention the catalyst is jest dodecacarbonyltriruthenium (0) of formula 8.

In contrast to the hitherto proposed solutions, the method of synthesis according to the invention permits obtaining silylsubstituted 1,2-alkynes of general formula 1, with R¹, R², as specified above, in high yields in a single-step process and with a considerable reduction of formation of side products relative to their formation in the majority of the hitherto known processes. Another advantage of the method of synthesis proposed in the invention is the use of a low amount of ruthenium complex 0.01-2% molar ratio.

Silylsubstituted alkynes have a number of applications in organic synthesis (Kawanami, Y.; Katsuki, T.; Yamaguchi, M. Tetrahedron Lett. 1983, 24, 5131-5132; Greene, T. W.; Wuts, P. G. M. Protective Groups in Organic Synthesis, Wiley, N.Y., 1999; Saeeng, R.; Sirion, U.; Sahakitpichan, P.; Isobe, M. Tetrahedron Lett. 2003, 44, 6211-6215; Anderson, J. C.; Munday, R. H., J. Org. Chem. 2004, 69, 8971-8974; Lettan II, R. B.; Scheidt, K. A. Org. Lett. 2005, 7, 3227-3230). They are used in different processes as e.g. in metathesis of alkynes (Fürstner, A.; Mathes, Ch. Org. Lett. 2001, 3, 221-223; Brizius, G.; Bunz, U. H. F. Org. Lett. 2002, 4, 2829-2831), or in synthesis of compounds being potential insecticides (Palmer, C. J.; Casida, J. E. J. Agric. Food Chem. 1989, 37, 213-316; Palmer, C. J.; Smith, I. H.; Moss, M. D. V.; Casida, J. E. J. Agric. Food Chem. 1990, 38, 1091-1093; Palmer, C. J.; Cole, L. M; Smith, I. H.; Moss, M. D. V.; Casida, J. E. J. Agric. Food Chem. 1991, 39, 1335-1341).

The invention is illustrated by the few examples given below. The structure of the new silylsubstituted 1,2-alkynes has been confirmed by GC-MS and NMR spectroscopy.

### Example I

In a reactor equipped with a reflux and a stirrer, in argon atmosphere, a portion of 0.07 g of carbonylchlorohydridobis(tricyclohexylphosphine)ruthenium (II) was placed, to which 14 mL of toluene, 3.5 mL of dimethylphenylvinylsilane and 1.7 mL triethylsilylethyne were subsequently added. The reaction mixture was heated for 24 hours at 120° C. The catalysts were removed from the raw product on a chromatographic column filled with silica and then the product was distilled. The compound obtained was 1-dimethylphenylsilyl-2-(triethylsilyl)ethyne in the yield of 94% of the pure product and 100% yield of the raw product.

Results of the GCMS analysis: m/z (%): 274 (23) [M⁺], 259 (34), 246 (100), 218 (89), 189 (68), 159 (12), 145 (13), 135 (34), 105 (36), 91 (10), 58 (14), 53 (18)
Spectroscopic characterization of the product: ¹H NMR (CDCl₃) δ (ppm): 0.42 (s, CH₃SiC≡); 0.63-0.68 (tr, CH₃CH₂SiC≡); 1.00-1.05 (qu, CH₃CH₂SiC≡); 7.39-7.40 (m, C₆H₅SiC≡) ¹³C NMR (CDCl₃) δ (ppm): −0.68 (CH₃SiC≡); 4.49 (CH₃CH₂SiC≡); 7.44 (CH₃CH₂SiC≡);

### 113.57, 112.81 (C≡C); 127.79-137.11 (C₆H₅SiC≡)

²⁹Si NMR (CDCl₃) δ (ppm): −20.07; −19.10

### Example II

As in example I, 4.0 mL of dimethylphenylvinylsilane were reacted with 1.8 mL of tertbutyldimethylsilylethyne in the presence of 10.2 mL of toluene and 0.07 g of carbonylchlorohydridobis(tricyclohexylphosphine)ruthenium (II). The compound obtained was 1-dimethylphenylsilyl-2-(tertbutyldimethylsilyl)ethyne in the yield of 70% of the pure product and 77% yield of the raw product.

Results of GCMS analysis: m/z (%): 274 (47) [M⁺], 259 (74), 218 (100), 157 (39), 135 (46), 105 (11), 74 (69), 53 (16)
Spectroscopic characterisation of the product:

¹H NMR (CDCl₃) δ (ppm): 0.16 (s, CH₃((CH₃)₃C)SiC-≡); 0.43 (s, CH₃(C₆H₅)SiC≡); 0.98 (s, CH₃((CH₃)₃C)SiC≡); 7.37-7.68 (m, C₆H₅SiC≡)

¹³C NMR (CDCl₃) δ (ppm): −4.54 (CH₃((CH₃)₃C)SiC≡); −0.59 (CH₃(C₆H₅)SiC≡); 16.62 (CH₃((CH₃)₃C)SiC≡); 26.13 (CH₃((CH₃)₃C)SiC≡); 112.07, 114.40 (C≡C); 127.07-136.91 (C₆H₅SiC≡)
²⁹Si NMR (CDCl₃) δ (ppm): −20.06; −5.95

### Example III

As in example I, 8.8 mL of dimethylphenylvinylsilane were reacted with 1.2 mL of 3,3-dimethyl-1-butyne in the presence of 0.07 g of carbonylchlorohydridobis(tricyclohexylphosphine)ruthenium (II) and 9.3 mL of toluene. The compound obtained was 3,3-dimethyl-1-(dimethylphenylsilyl)-1-butyne in the yield of 90% of the pure product and 100% yield of the raw product.

Results of GCMS analysis: m/z (%): 216 (21) [M⁺], 201 (100), 185 (5), 159 (33), 135 (6), 105 (9)
Spectroscopic characterization of the product:

¹H NMR (CDCl₃) δ (ppm): 0.36 (s, (CH₃)₂Si); 1.25 (s, (CH₃)₃C); 7.37-7.68 (m, C₆H₅SiC≡) ¹³C NMR (CDCl₃) δ (ppm): −0.59 (CH₃(C₆H₅)SiC≡); 16.62 (CH₃((CH₃)₃C)SiC≡); 29.01 ((CH₃)₃C); 30.82 ((CH₃)₃C); 112.07, 88.40 (C≡C); 127.07-136.91 (C₆H₅SiC≡)

### Example IV

As in example I, 3.8 mL of dimethylphenylvinylsilane were reacted with 0.9 mL ethynylcyclohexane in the presence of 0.07g of iodotris(triphenylphosphine)rhodium (I) at 100° C. The compound obtained was (dimethylphenylsilylethynyl)cyclohexane in the yield of 65% of the pure product and 100% yield of the raw product.

Results of GCMS analysis: m/z (%): 227 (100) [M⁺-CH₃], 163 (12), 145 (31), 121 (8), 105 (10), 78 (7), 53 (7)
Spectroscopic characterization of the product:

¹H NMR (CDCl₃) δ (ppm): 0.38 (s, CH₃Si); 1.2-2.4 (m, C₆H₁₁); 7.33-7.68 (m, C₅H₅) ¹³C NMR (CDCl₃) δ (ppm): 0.3 (CH₃Si); 24.8-32.6 (C₆H₁₁); 81.6, 113.7 (C≡C); 127.6-137.8 (C₅H₅)

²⁹Si NMR (CDCl₃) δ (ppm): −20.02

### Example V

As in example I 7.9 mL dimethylphenylvinylsilane were reacted with 0.95 mL 1-heptyne in the presence of 0.07 g carbonylchlorohydridobis(tricyclohexylphosphine)rutheniuln (II) and 5.55 mL of toluene. The compound obtained was 1-(dimethylphenylsilyl)-1-heptyne in the yield of 95% of the pure product and 100% yield of the raw product.

Results of the GCMS analysis m/z (%): 215 (100) [M⁺-CH₃], 174 (28), 159 (21), 145 (25), 135 (14), 121 (30), 105 (14), 53 (10)
Spectroscopic characterization of the product:

¹H NMR (CDCl₃) δ (ppm): 0.09 (s, CH₃Si); 0.33-2.30 (m, C₅H₁₁); 7.36-7.66 (m, C₅H₅) ¹³C NMR (CDCl₃) ε (ppm): −0.4 (CH₃Si); 14.0-31.1 (C₅H₁₁); 82.1, 109.6 (C≡C); 127.6-137.7 (C₅H₅)

²⁹Si NMR (CDCl₃) δ (ppm): −20.09

### Example VI

As in example I, 4.38 mL of dimethylphenylvinylsilane were reacted with 0.62 mL of ethynylcyclohexane in the presence of 4.64 mL of toluene and 0.07 g of carbonylchlorohydridobis(tricyclohexylphosphine)ruthenium (II). The compound obtained was (dimethylphenylsilylethynyl)cyclohexane in the yield of 60% of pure product and 67% of raw product. The product characteristic is as in example IV.

### Example VII

As in example I, 5.65 mL of dimethylphenylvinylsilane were reacted with 1.85 mL of triethylsilylethyne in the presence of 0.07 g di-μ-iodobis(1,5-cyclooctadiene)dirhodium (I) at 130° C. The compound obtained was 1-dimethylphenylsilyl-2-(triethylsilyl)ethyne in the yield of 70% of pure product and 90% of raw product. The product characteristic is as in example I.

### Example VIII

As in example I 5.65 mL dimethylphenylvinylsilane were reacted with 1.38 mL dimethylphenylsilylethyne in the presence of argon 0.07 g di-μ-iodobis(1,5-cyclooctadiene)dirhodium (I) at 130° C. The compound obtained was 1,2-bis(dimethylphenylsilyl)ethyne in the yield of 80% of the pure product and 100% of raw product.

Results of the GCMS analysis m/z (%): 294 (9) [M⁺], 279 (100) [M⁺-CH₃], 263 (2), 219 (10), 159 (4), 135 (13), 105 (10), 91 (5), 73 (3), 53 (5)
Spectroscopic characterization of the product:

¹H NMR (CDCl₃) δ (ppm): 0.37 (s,CH₃SiC≡); 7.37-7.40 (m, C₆H₅SiC≡) ¹³C NMR (CDCl₃) δ (ppm): −0.68 (CH₃SiC≡); 113.81 (C≡C); 127.80-136.80 (C₆H₅SiC≡)

### Example IX

As in example I 3.76 mL dimethylphenylvinylsilane were reacted with 0.92 mL dimethylphenylsilylethyne in the presence of 0.07 g iodotris(triphenylphosphine)rhodium (I) at 100° C. The compound obtained was 1,2-bis(dimethylphenylsilyl)ethyne in the yield of 60% of the pure product and 100% of raw product. The product characteristic is as in example VIII.

### Example X

As in example I 5.65 mL dimethylphenylvinylsilane were reacted with 1.35 mL 1-heptyne in the presence of 0.07 g di-μ-iodobis(1,5-cyclooctadiene)dirlhodium (I) at 130° C. The compound obtained was 1-dimethylphenylsilyl-1-heptyne in the yield of 65% of the pure product and 80% of raw product. The product characteristic is as in example V.

### Example XI

As in example I 5.65 mL dimethylphenylvinylsilane were reacted with 1.33 mL ethynylcyclohexane in the presence of 0.07 g di-μ-iodobis(1,5-cyclooctadiene)dirhodium (I) at 130° C. The compound obtained was (dimethylphenylsilylethynyl)cyclohexane in the yield of 60% of the pure product and 100% of raw product. The product characteristic is as in example IV.

### Example XII

As in example I 5.65 mL dimethylphenylvinylsilane were reacted with 2.32 mL triisopropylsilylethyne in the presence of 0.07 g di-μ-iodobis(1,5-cyclooctadiene)dirhodium (I) at 130° C. The compound obtained was 1-triisopropylsilyl-2-(dimethylphenylsilyl)ethyne in the yield of 95% of the pure product and 100% of raw product. Results of the GCMS analysis m/z (%): 301 (21) [M⁺-CH₃], 273 (100), 246 (22), 232 (50), 203 (8), 157 (28), 135 (29), 105 (8), 91 (3), 73 (14)

Spectroscopic characterization of the product:

¹H NMR (CDCl₃) δ (ppm): 0.40 (s,CH₃SiC≡); 1.06-1.2 (m, (CH₃)₂CH); 7.37-7.40 (m, C₆H₅SiC≡)

¹³C NMR (CDCl₃) δ (ppm): −2.16 (CH₃Si); −0.68 (CH₃SiC≡); 11.24 ((CH₃)₂CHSi); 18.70 ((CH₃)₂CHSi); 110.1, 113.81 (C≡C); 127.80-136.80 (C₆H₅SiC≡)

### Example XIII

As in example I 4.45 mL dimethylphenylvinylsilane were reacted with 1.46 mL triethylsilylethyne in the presence of 10.42 mL dichloromethane, and 0.07 g diacetonitrilecarbonylhydridobis(tricyclohexylphosphine)ruthenium (II) tetrafluoroborate at 100° C. The compound obtained was 1-dimethylphenylsilyl-2-(triethylsilyl)ethyne in the yield of 40% of the pure product and 43% of raw product. The product characteristic is as in example I.

### Example XIV

As in example I 3.44 mL dimethylphenylvinylsilane were reacted with 1.47 mL triethylsilylethyne in the presence of 0.07 g dodecacarbonyltriruthenium (0) and 11.5 mL of toluene at 120° C. The compound obtained was 1-dimethylphenylsilyl-2-(triethylsilyl)ethyne in the yield of 10% of the pure product and 20% of raw product. The product characteristic is as in example I.

### Example XV

In a reactor equipped with a reflux and a stirrer, in argon atmosphere, a portion of 0.07 g of carbonylchlorohydridobis(tricyclohexylphosphine)ruthenium (II) was placed, to which 11.9 mL of toluene, 5.5 mL of dimethylphenylvinylsilane and 1.9 mL 1-ethynyl-1-(trimethylsiloxy)cyclohexane were subsequently added. The reaction mixture was heated for 24 hours at 110° C. The catalyst was removed from the raw product on a chromatographic column filled with silica modified with 15% wt. Et₃N and then the product was distilled. The compound obtained was 1-dimethylphenylsilylethynyl-1-(trimethylsiloxy)cyclohexane in the yield of 88% of the pure product and 93% of raw product.

Results of the GCMS analysis m/z (%): 315 (47) [M⁺-CH₃], 287 (44), 242 (12), 196 (15), 171 (100), 159 (14), 147 (42), 133 (38), 73 (22), 45 (22)
Spectroscopic characterization of the product:

¹H NMR (CDCl₃) δ (ppm): 0.18 (s,CH₃SiO); 0.42 (s, CH₃(C₆H₅)SiC≡); 1.55-1.91 (m, (C₆H₁₀)C≡); 7.37-7.66 (m, (C₆H₅)SiC≡)

¹³C NMR (CDCl₃) δ (ppm): −0.85 (CH₃(C₆H₅)SiC≡); 2.08 (CH₃SiO); 21.39-70.26 ((C₆H₁₀)C≡); 87.49, 111.96 (C≡C); 127.81-137.13 ((C₆H₅)SiC≡)
²⁹Si NMR (CDCl₃) δ (ppm): −19.38; 16.00

### Example XVI

As in example XV 3.8 mL dimethylphenylvinylsilane were reacted with 1.4 mL 1-ethynyl-1-(trimethylsiloxy)cyclohexane in the presence of 0.07 g iodotris(triphenylphosphine)rhodium (I) at 100° C. The compound obtained was 1-dimethylphenylsilylethynyl-1-(trimethylsiloxy)cyclohexane in the yield of 78% of the pure product and 100% of raw product. The product characteristic is as in example XVIII.

### Example XVII

As in example XV 5.3 mL dimethylphenylvinylsilane were reacted with 2.8 mL 1-ethynyl-1-(trimethylsiloxy)cyclohexane in the presence of 0.07 g carbonylchlorohydridobis(triisopropylphosphine)ruthenium (II) and 20.7 mL of toluene, at 100° C. The compound obtained was 1-dimethylphenylsilylethynyl-1-(trimehylsiloxy)cyclohexane in the yield of 89% of the pure product and 93% of raw product. The product characteristic is as in example XV.

### Example XVIII

As in example XV 5.26 mL dimethylphenylvinylsilane were reacted with 1.35 mL 3-methyl-3-ethoxy-1-pentyne in the presence of 12.69 mL of toluene and 0.07 g carbonylchlorohydridobis(tricyclohexylphosphine)ruthenium (II) at 120° C. The compound obtained was 3-methyl-3-ethoxy-1-(dimethylphenylsilyl)-1-pentyne in the yield of 50% of the pure product and 63% of raw product.

Results of the GCMS analysis m/z (%): 245 (5) [M⁺-CH₃], 231 (100), 187 (10), 159 (18), 145 (12), 125 (37), 83 (12), 75 (19)
Spectroscopic characterization of the product:

¹H NMR (CDCl₃) δ (ppm): 0.40 (s, CH₃Si); 0.97-1.02 (tr, CH₃CH₂C); 1.18-1.22 (tr, CH₃CH₂O); 1.41 (s, CH₃C); 1.69-1.74 (qu, CH₃CH₂C); 3.59-3.63 (qu, CH₃CH₂O); 7.36-7.65 (m, C₅H₅Si)

¹³C NMR (CDCl₃) δ (ppm): −0.52, 1.15 (CH₃Si); 8.78 (CH₃CH₂C); 15.90 (CH₃CH₂O); 25.84 (CH₃C); 34.29 (CH₃CH₂C); 59.29 (CH₃CH₂O); 73.86 (CH₃C); 86.78, 109.52 (C≡C); 127.71-137.19 (C₅H₅Si)
²⁹Si NMR (CDCl₃) δ (ppm): −19.10

### Example XIX

As in example XV 7.0 mL dimethylphenylvinylsilane were reacted with 2.3 mL 3-methyl-3-trimethylsiloxy-1-pentyne in the presence of 9.96 mL of toluene and 0.07 g carbonylchlorohydridobis(tricyclohexylphosphine)ruthenium (II) at 120° C. The compound obtained was 3-methyl-3-trimethylsiloxy-1-(dimethylphenylsilyl)-1-pentyne in the yield of 90% of the pure product and 92% of raw product.

Results of the GCMS analysis m/z (%): 289 (14) [M⁺-CH₃], 275 (100), 145 (8), 135 (18), 133 (33), 73 (17)
Spectroscopic characterization of the product:

¹H NMR (CDCl₃) δ (ppm): 0.09 (s, CH₃SiO); 0.18 (s, CH₃PhSi); 0.98-1.01 (tr, CH₃CH₂); 1.46 (s, CH₃C); 1.64-1.69 (m, CH₃CH₂); 7.37-7.65 (m, C₅H₅Si)

¹³C NMR (CDCl₃) δ (ppm): 1.16 (CH₃Si); 2.04 (CH₃SiO); 9.16 (CH₃CH₂); 30.80 (CH₃C); 37.9 (CH₃CH₂); 70.24 (CH₃C); 86.33, 111.78 (C≡C); 127.72-136.913 (C₅H₅Si)
²⁹Si NMR (CDCl₃) δ (ppm): −19.15; 16.18

### Example XX

As in example XV 11.76 mL dimethyl(trimethylsiloxy)vinylsilane were reacted with 2.3 mL 3-methyl-3-trimethylsiloxy-1-pentyne in the presence of 5.24 mL of toluene and 0.07 g carbonylchlorohydridobis(tricyclohexylphosphine)ruthenium (II) (9.65×10⁻⁵ mol) at 120° C. The compound obtained was 3-methyl-3-trimethylsiloxy-1-(dimethyl(trimethylsiloxy)silyl)-1-pentyne in the yield of 85% of the pure product and 90% of raw product.

Results of the GCMS analysis m/z (%): 301 (26) [M⁺-CH₃], 287 (100), 221 (14), 147 (32), 73 (22)
Spectroscopic characterization of the product:

¹H NMR (CDCl₃) δ (ppm): 0.11 (CH₃Si); 0.18-0.20 (s, CH₃SiO); 0.95-0.99 (tr, CH₃CH₂); 1.41 (s, CH₃C); 1.60-1.64 (m, CH₃CH₂)

¹³C NMR (CDCl₃) δ (ppm): 1.16 (CH₃Si); 1.9-2.3 (CH₃SiO); 9.09 (CH₃CH₂); 30.64 (CH₃C); 37.8 (CH₃CH₂); 70.05 (CH₃C); 88.31, 108.55 (C≡C)
²⁹Si NMR (CDCl₃) δ (ppm): −16.74; 12.49; 16.02

### Example XXI

As in example XV 8.55 mL dimethyl(trimethylsiloxy)vinylsilane were reacted with 1.76 mL 1-ethynyl-1-(trimethylsiloxy)cyclohexane in the presence of 8.96 mL of toluene and 0.07 g carbonylchlorohydridobis(tricyclohexylphosphine)ruthenium (II) at 120° C. The compound obtained was 1-dimethyl(trimethylsiloxy)silylethynyl-1-(trimethylsiloxy)cyclohexane in the yield of 90% of the pure product and 100% of raw product.

Results of the GCMS analysis m/z (%): 328 (100) [M⁺-CH₃], 314 (31), 300 (97), 222 (80), 108 (18), 195 (8), 171 (19), 147 (38), 74 (55), 45 (21)
Spectroscopic characterization of the product:
¹H NMR (CDCl₃) δ (ppm): 0.09-0.19 (s, CH₃SiO, CH₃Si ); 1.21-2.12 (m, (C₆H₁₀)C≡);
¹³C NMR (CDCl₃) δ (ppm): 1.70 (CH₃Si); 2.07 (CH₃SiO); 23.07-70.03 ((C₆H₁₀)C≡); 89.20, 108.66 (C≡C)

### Example XXII

As in example XV 14.34 mL methylbis(trimethylsiloxy)vinylsilane were reacted with 1.76 mL 1-ethynyl-1-(trimethylsiloxy)cyclohexane in the presence of 2.9 mL of toluene and 0.07 g carbonylchlorohydridobis(tricyclohexylphosphine)ruthenium (II) at 120° C. The compound obtained was 1-methylbis(trimethylsiloxy)silylethynyl-1-(trimethylsiloxy)cyclohexane in the yield of 91% of the pure product and 100% of raw product.

Results of the GCMS analysis m/z (%): 401 (73) [M⁺-CH₃], 388 (14), 374 (47), 222 (100), 172 (15), 74 (24)
Spectroscopic characterization of the product:
¹H NMR (CDCl₃) δ (ppm): 0.07-0.19 (s, CH₃SiO, CH₃Si); 1.25-1.86 (m, (C₆H₁₀)C≡);
¹³C NMR (CDCl₃) δ (ppm): 1.03 (CH₃Si); 2.07 (CH₃SiO); 23.02-77.42 ((C₆H₁₀)C≡); 88.26, 106.47 (C≡C)

### Example XXIII

As in example XV 5.65 mL dimethylphenylvinylsilane were reacted with 1.89 mL 1-ethynyl-1-(trimethylsiloxy)cyclohexane in the presence of 0.07 g di-μ-iodobis(1,5-cyclooctadiene)dirhodium (I) at 130° C. The compound obtained was 1-dimethylphenylsilylethynyl-1-(trimethylsiloxy)cyclohexane in the yield of 95% of the pure product and 100% of raw product. The product characteristic is as in example XV .

### Example XXIV

As in example XV 5.65 mL dimethylphenylvinylsilane were reacted with 2.48 mL 3-methyl-3-trimethylsiloxy-1-pentyne in the presence of 0.07 g di-μ-iodobis(1,5-cyclooctadiene)dirhodium (I) at 130° C. The compound obtained was 3-methyl-3-trimethylsiloxy-1-(dimethylphenylsilyl)-1-pentyne in the yield of 90% of the pure product and 95% of raw product. The product characteristic is as in example XIX.

### Example XXV

As in example XV 3.76 mL dimethylphenylvinylsilane were reacted with 1.65 mL 3-methyl-3-trimethylsiloxy-1-pentyne in the presence of 0.07 g iodotris(triphenylphosphine)rhodium (I) at 100° C. The compound obtained was 3-methyl-3-trimethylsiloxy-1-(dimethylphenylsilyl)-1-pentyne in the yield of 50% of the pure product and 65% of raw product. The product characteristic is as in example XIX.

### Example XXVI

As in example XV 6.5 mL triethoxyvinylsilane were reacted with 1.89 mL 1-ethynyl-1-(trimethylsiloxy)cyclohexane in the presence of 0.07 g di-μ-iodobis(1,5-cyclooctadiene)dirhodium (I) at 130° C. The compound obtained was 1-triethoxysilylethynyl-1-(trimethylsiloxy)cyclohexane in the yield of 95% of the pure product and 100% of raw product. Results of GCMS analysis: [M⁺] (m/z) =358

Spectroscopic characterization of the product:
¹H NMR (CDCl₃) δ (ppm): 0.2 (s,CH₃SiOC≡); 1.22-1.27 (tr, CH₃CH₂OSi); 1.49-2.59 (m, (C₆H₁₀)-≡); 3.86-3.89 (qu, CH₃CH₂OSi)
¹³C NMR (CDCl₃) δ (ppm): 2.14 (CH₃SiOC≡); 18.13 (CH₃CH₂OSi); 58.96 (CH₃CH₂OSi); 23.14-70.09 ({C₆H₁₀}-≡); 81.24, 109.30 (C≡C)

### Example XXVII

As in example XV 9.23 mL methylbis(trimethylsiloxy)vinylsilane were reacted with 1.89 mL 1-ethynyl-1-(trimethylsiloxy)cyclohexane in the presence of 0.07 g di-μ-iodobis(1,5-cyclooctadiene)dirhodium (I) at 130° C. The compound obtained was 1-methylbis(trimethylsiloxy)silylethynyl-1-(trimethylsiloxy)cyclohexane in the yield of 80% of the pure product and 100% of raw product. The product characteristic is as in example XXII

### Example XXVIII

As in example XV 10.1 mL triethoxyvinylsilane were reacted with 1.7 mL triethylsilylethyne in the presence of 7.5 mL of toluene and 0.07 g carbonylchlorohydridobis(tricyclohexylphosphine)ruthenium (II) at 110° C. The compound obtained was 1-triethoxysilyl-2-(triethylsilyl)ethyne in the yield of 65% of the pure product and 90% of raw product.

Results of the GCMS analysis m/z=302
Spectroscopic characterization of the product:
¹H NMR (CDCl₃) δ (ppm): 0.55-0.57 (qu, CH₃CH₂SiC≡); 0.94-0.98 (tr, CH₃CH₂SiC≡); 1.15-1.19 (tr, CH₃CH₂OSiC≡); 3.73-3.78 (qu, CH₃CH₂OSiC≡)
¹³C NMR (CDCl₃) δ (ppm): 3.25 (CH₃CH₂SiC≡); 7.53 (CH₃CH₂SiC≡); 18.57 (CH₃CH₂OSiC≡); 58.13 (CH₃CH₂OSiC≡); 84,86, 106,15 (C≡C)

### Example XXIX

As in example XV 20.2 mL triethoxyvinylsilane were reacted with 1.2 mL 3,3-dimethyl-1-butyne in the presence of 6.3 mL of toluene and 0.07 g carbonylchlorohydridobis(tricyclohexylphosphine)ruthenium (II) at 100° C. The compound obtained was 3,3-dimethyl-1-(triethoxysilyl)-1-butyne in the yield of 85% of the pure product and 93% of raw product.

Results of the GCMS analysis m/z=244
Spectroscopic characterization of the product:
¹H NMR (CDCl₃) δ (ppm): 3.86 (q, CH₃CH₂OSi); 1.26-1.24 (m, CH₃CH₂OSi, (CH₃)C) ¹³C NMR (CDCl₃) δ (ppm): 18.2 (CH₃CH₂OSi); 30.8 ((CH₃)C, CH₃CH₂OSi); 59.1 (CH₃CH₂OSi); 73.8, 115.9 (C≡C)

### Example XXX

As in example XV 8.1 mL triethoxyvinylsilane were reacted with 1.9 mL 1-ethynyl-1-(trimethylsiloxy)cyclohexane in the presence of 9.3 mL of toluene and 0.07 g carbonylchlorohydridobis(tricyclohexylphosphine)ruthenium (II) at 110° C. The compound obtained was 1-triethoxysilylethynyl-1-(trimethylsiloxy)cyclohexane in the yield of 92% of the pure product and 100% of raw product. The product characteristic is as in example XXVI

### Example XXXI

As in example XV 8.5 mL triethoxyvinylsilane were reacted with 1.6 mL 1-ethynyl-1-(trimethylsiloxy)cyclohexane in the presence of 0.07 g diacetonitrilecarbonylhydridobis(tricyclohexylphosphine)ruthenium (II) tetrafluoroborate at 120° C. The compound obtained was 1-triethoxysilylethynyl-1-(trimethylsiloxy)cyclohexane in the yield of 95% of the pure product and 100% of raw product. The product characteristic is as in example XXVI

### Example XXXII

As in example XV 11.8 mL triethoxyvinylsilane were reacted with 2.2 mL 1-ethynyl-1-(trimethylsiloxy)cyclohexane in the presence of 0.07 g diacetonitrilecarbonylhydridobis(triisopropylphosphine)rutheniun (II) tetrafluoroborate at 120° C. The compound obtained was 1-triethoxysilylethynyl-1-(trimethylsiloxy)cyclohexane in the yield of 92% of the pure product and 98% of raw product. The product characteristic is as in example XXVI

1. New silylsubstituted 1,2-alkynes of general formula 1, in which R¹ stands for a trialkoxysilyl group, phenyldimethylsilyl group, dimethyl(trimethylsiloxy)silyl group or methylbis(trimethylsiloxy)silyl group; while R stands for alkyl, trialkylsilyl group, 1-trimethylsiloxycycloalkyl group, cycloalkyl group, tertbutyl group, 1-trimethylsiloxyalkyl group, tertbutyldimethylsilyl group or 1-alkoxyalkyl group.

2. The synthesis of silylsubstituted 1,2-alkynes of general formula 1, in which R¹ stands for a trialkoxysilyl group, phenyldimethylsilyl group, dimethyl(trimethylsiloxy)silyl group or methylbis(trimethylsiloxy)silyl group, while R² stands for an alkyl group, tertbutyl group, cycloalkyl group, 1-trimethylsiloxycycloalkyl group, phenyldimethylsilyl group, trialkylsilyl group with all alkyl substituents the same, tertbutyldimethylsilyl group, 1-trimethylsiloxyalkyl group or 1-alkoxyalkyl group, in which process a relevant alkene of general formula 2, with R¹ specified as above is subjected to silylative coupling with a terminal alkyne of general formula 3, with R² specified as above, in the presence of a catalyst of general formula 4 with R³ standing for a cyclohexyl group or isopropyl group; the reaction is conducted in temperatures from the range 100-130° C., possibly in an organic solvent, preferably a hydrocarbon or aromatic solvent, preferably in toluene, in a neutral gas atmosphere.

3. The method of synthesis of silylsubstituted 1,2-alkynes of general formula 1, in which R¹ stands for a trialkoxylsilyl group, phenyldimethylsilyl group dimethyl(trimethylsiloxy)silyl group or methylbis(trimethylsiloxy)silyl group, while R² stands for alkyl, tertbutyl, cycloalkyl, 1-trimethylsiloxycycloalkyl group, phenyldimethylsilyl group, trialkylsilyl group, tertbutyldimethylsilyl group, 1-trimethylsiloxalkyl group or 1-alkoxyalkyl group, in which process a relevant alkene of general formula 2 with R¹ specified as above is subjected to silylative coupling with a terminal alkyne of general formula 3 with R² specified as above, in the presence of a catalyst of general formula 5, with R³ standing for a cyclohexyl or isopropyl group; the reaction is conducted in temperatures from the range 100-130° C., possibly in an organic solvent, preferably a hydrocarbon or aromatic solvent, preferably in toluene, in a neutral gas atmosphere.

4. The method of synthesis of silylsubstituted 1,2-alkynes of general formula 1, in which R¹ stands for a trialkoxylsilyl group, phenyldimethylsilyl group dimethyl(trimethylsiloxy)silyl group or methylbis(trimethylsiloxy)silyl group, while R² stands for alkyl, tertbutyl, cycloalkyl, 1-trimethylsiloxycycloalkyl group, phenyldimethylsilyl group, trialkylsilyl group, tertbutyldimethylsilyl group, 1-trimethylsiloxyalkyl group or 1-alkoxyakyl group, in which process a relevant alkene of general formula 2 with R¹ specified as above is subjected to silylative coupling with a terminal alkyne of general formula 3, with R² specified as above in the presence of iodotris(triphenylphosphine)rhodium (I) of formula 6 as a catalyst; the reaction is conducted in temperatures from the range 100-130° C., possibly in an organic solvent, preferably a hydrocarbon or aromatic solvent, preferably in toluene, in a neutral gas atmosphere.

5. The method of synthesis of silylsubstituted 1,2-alkynes of general formula 1, in which R¹ stands for a trialkoxylsilyl group, phenyldimethylsilyl group, dimethyl(trimethylsiloxy)silyl group or methylbis(trimethylsiloxy)silyl group, while R² stands for alkyl, tertbutyl, cycloalkyl, 1-trimethylsiloxycycloalkyl group, phenyldimethylsilyl group, trialkylsilyl group, tertbutyldimethylsilyl group, 1-trimethylsiloxyalkyl group or 1-alkoxyalkyl group, in which process a relevant alkene of general formula 2, with R¹ specified as above, is subjected to silylative coupling with a terminal alkyne of general formula 3, with R² specified as above, in the presence of di-μ-iodobis(1,5-cyclooctadiene)dirhodium (I) of formula 7 as a catalyst; the reaction is conducted in temperatures from the range 100-130° C., possibly in an organic solvent, preferably in a hydrocarbon or aromatic solvent, preferably in toluene, in a neutral gas atmosphere.

6. The method of synthesis of silylsubstituted 1,2-alkynes of general formula 1, in which R¹ stands for a trialkoxysilyl group, phenyldimethylsilyl group, dimethyl(trimethylsiloxy)silyl group or metylbis(trimethylsiloxy)silyl group, while R² stands for alkyl, tertbutyl, cycloalkyl, a 1-trimethylsiloxycckloalkyl group, phenyldimethylsilyl group, trialkylsilyl group, tertbutyldimethylsilyl group, 1-trimethylsiloxyalkyl group or 1-alkoxyalkyl group, in which process a relevant alkene of general formula 2 with R¹ specified as above is subjected to silylative coupling with a terminal alkyne of general formula 3, with R² specified as above, in the presence of dodecacarbonyltriruthenium (0) of formula 8 as a catalyst; the reaction is conducted in temperatures from the range 100-130° C., possibly in an organic solvent, preferably a hydrocarbon or aromatic solvent, preferably in toluene, in a neutral gas atmosphere.
